(19) United States
(12) Patent Application Publication
(10) Pub. No.: US 2026/0171949 A1
(43) Pub. Date: Jun. 18, 2026

(54) MULTI-INVERTER MOTOR CONTROL

(71) Applicant: BETA AIR LLC, South Burlington, VT (US)

(72) Inventors: Tyler John Arsenault, Cambridge, VT (US); Michael John Shaw, St. George, VT (US); David Lawrence Churchill, Burlington, VT (US)

(21) Appl. No.: 18/985,797

(22) Filed: Dec. 18, 2024

(51) Int. Cl. H02P 27/08

(52) U.S. Cl. CPC H02P 27/08

(57) ABSTRACT

According to at least one implementation, a method includes identifying status information associated with two or more inverters for a motor and identifying a target speed for the motor. The method further comprises generating an update for at least one inverter of the two or more inverters based on the target speed and the status information. The method also includes communicating the update to the at least one inverter.

### BACKGROUND

An inverter can control a motor by converting direct current (DC) power to alternating current (AC) power with adjustable frequency, current, and voltage. The inverter's primary function is to regulate the motor's speed and torque by modulating the AC signal's frequency and amplitude. Using techniques such as Pulse Width Modulation (PWM), the inverter can control the power delivery, enabling smooth acceleration, deceleration, and efficient performance across varying load conditions. This setup allows for speed control, energy savings, and enhanced motor protection by preventing issues such as overcurrent.

### SUMMARY

This disclosure relates to systems and methods for controlling multiple inverters associated with a single motor. In at least one example, a controller can be communicatively coupled to two or more inverters associated with an inverter. The inverter can be configured to manage frequency, current, or voltage from the inverters to support at least the desired motor speed. In at least one implementation, the controller can be configured to identify a target speed for the motor and identify status information associated with the two or more inverters. In some examples, the status information is provided from two or more inverters. In some examples, the status information indicates whether an inverter is functional or non-functional. For instance, if a health check signal is not received from the inverter within a period, the controller can be configured to identify the inverter as non-functional. In some examples, the status information includes temperature information for the inverter. In some examples, the status information provides power consumption information for the inverter.

The controller can be configured to generate an update for at least one inverter of the two or more inverters based on the target speed and the status information. In at least one example, the update permits a first set of one or more inverters for the motor to support failover responsibilities for a second set of one or more inverters. In some implementations, the failover responsibilities can be made in response to failure in the second set of inverters. In some implementations, the failover responsibilities can be made based on temperature or power status information in the second set of inverters. In at least one implementation, the update to an inverter can be used to change the voltage, current, and/or frequency supplied by the inverter to support the overall functionality of the motor (e.g., speed and torque).

In some aspects, the techniques described herein relate to a method including: in a controller: identifying first status information associated with a first inverter for a motor and second status information associated with a second inverter for the motor; identifying a target speed for the motor; generating at least one update for the first inverter or the second inverter based on the target speed, the first status information and the second status information; and communicating the at least one update to the first inverter or the second inverter.

In some aspects, the techniques described herein relate to a method, further including, in the controller, identifying an existing speed or an existing torque for the motor from one or more sensors, and wherein generating the at least one update for the first inverter or the second inverter is further based on the existing speed or the existing torque for the motor.

In some aspects, the techniques described herein relate to a method, further including: identifying that a third inverter for the motor is non-functional, wherein generating the at least one update for the first inverter or the second inverter is further based on identifying that the third inverter for the motor is non-functional, wherein the at least one update replaces a function of the third inverter using the first inverter and the second inverter.

In some aspects, the techniques described herein relate to a method, wherein identifying the first status information and the second status information includes identifying heat information or power consumption information associated with the first inverter and the second inverter.

In some aspects, the techniques described herein relate to a method, wherein the controller includes a first controller, and the method further including: in a second controller: identifying a failure associated with the first controller; and in response to identifying the failure associated with the first controller: identifying third status information associated with the first inverter and the second inverter; generating at least one additional update for the first inverter or the second inverter based on the target speed and the third status information; and communicating the at least one additional update to the first inverter and the second inverter.

In some aspects, the techniques described herein relate to a method, wherein identifying the failure associated with the first controller includes identifying that a message was not received from the first controller within a period.

In some aspects, the techniques described herein relate to a method, further including: in the second controller and prior to the failure: obtaining state information from the first controller, the state information including at least configuration information for the first inverter and the second inverter.

In some aspects, the techniques described herein relate to a method, wherein communicating the at least one update to the first inverter or the second inverter includes communicating the at least one update to the first inverter or the second inverter using a Fibre Channel protocol.

In some aspects, the techniques described herein relate to a method, wherein the at least one update includes a change of frequency, voltage, or current supplied by the first inverter or the second inverter.

In some aspects, the techniques described herein relate to a system including: a motor; a first inverter to support motion of the motor; a second inverter to support motion of the motor; and a controller communicatively coupled to the first inverter and the second inverter and configured to: identify status information associated with each of the first inverter and the second inverter; identify a target speed for the motor; generate updates for the first inverter or the second inverter based on the target speed and the status information; and communicate the updates to the first inverter and the second inverter.

In some aspects, the techniques described herein relate to a system, wherein the controller is further configured to: identify a power target for the motor, wherein generating the updates for the first inverter and the second inverter based on the target speed and the status information is further based on the power target for the motor.

In some aspects, the techniques described herein relate to a system, wherein the controller is further configured to: identify that a third inverter to support motion of the motor is non-functional, wherein generating the updates for the first inverter and the second inverter is further based on identifying that the third inverter for the motor is non-functional, wherein the updates replace a function of the third inverter using the first inverter and the second inverter.

In some aspects, the techniques described herein relate to a system, wherein identifying the status information includes identifying heat information or power consumption information associated with the first inverter and the second inverter.

In some aspects, the techniques described herein relate to a system, wherein the controller includes a first controller, and wherein the system further includes a second controller communicatively coupled to the first controller, the first inverter, and the second inverter, and the second controller configured to: identify a failure associated with the first controller; in response to identifying the failure associated with the first controller: identify second status information associated with the first inverter and the second inverter; generate second updates for the first inverter and the second inverter based on the target speed and the second status information; and communicate the second updates to the first inverter and the second inverter.

In some aspects, the techniques described herein relate to a system, wherein identifying the failure associated with the first controller includes identifying that a message was not received from the first controller within a period.

In some aspects, the techniques described herein relate to a system, wherein communicating the updates to the first inverter and the second inverter includes communicating the updates to the first inverter and the second inverter using a Fibre Channel protocol.

In some aspects, the techniques described herein relate to a system, wherein the updates include a change of frequency, voltage, or current supplied by the first inverter and the second inverter.

In some aspects, the techniques described herein relate to a computer-readable storage medium having program instructions stored thereon that, when executed by at least one processor, cause the at least one processor to execute operations, the operations including: identifying status information associated with at least a first inverter, a second inverter, and a third inverter for a motor; identifying a target speed for the motor; generating updates for the first inverter and the second inverter based on the target speed and the status information; and communicating the updates to the first inverter and the second inverter.

In some aspects, the techniques described herein relate to a computer-readable storage medium, wherein the operations further include: identifying that the third inverter is non-functional, wherein generating the updates for the first inverter and the second inverter is further based on identifying that the third inverter is non-functional, wherein the updates replace a function of the third inverter using the first inverter and the second inverter.

In some aspects, the techniques described herein relate to a computer-readable storage medium, wherein identifying the status information includes identifying heat information or power consumption information associated with the first inverter, the second inverter, and the third inverter.

The accompanying drawings and the description below outline the details of one or more implementations. Other features will be apparent from the description, drawings, and claims.

### BRIEF DESCRIPTION OF THE DRA WINGS

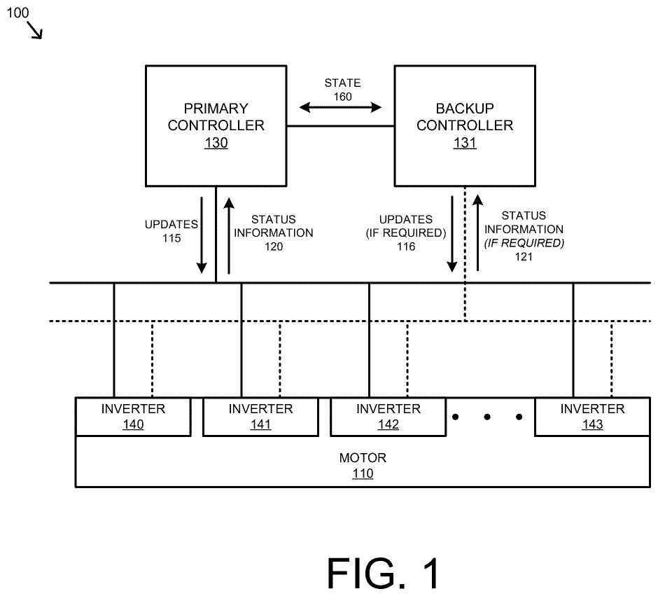

FIG. 1 illustrates a system that manages inverters for a motor according to an implementation.

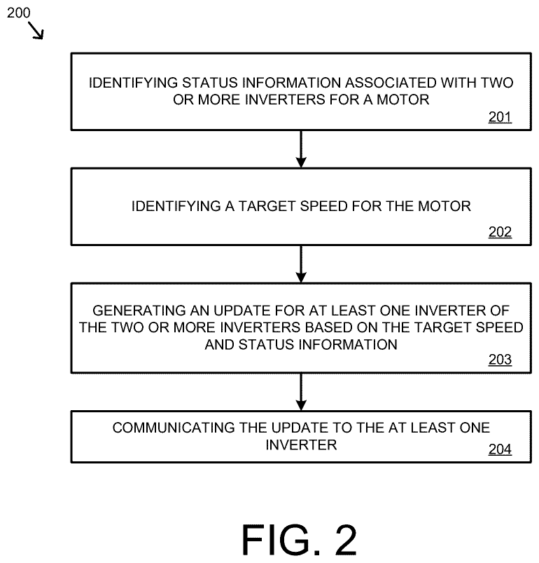

FIG. 2 illustrates a method of operating a controller to manage inverters for a motor according to an implementation.

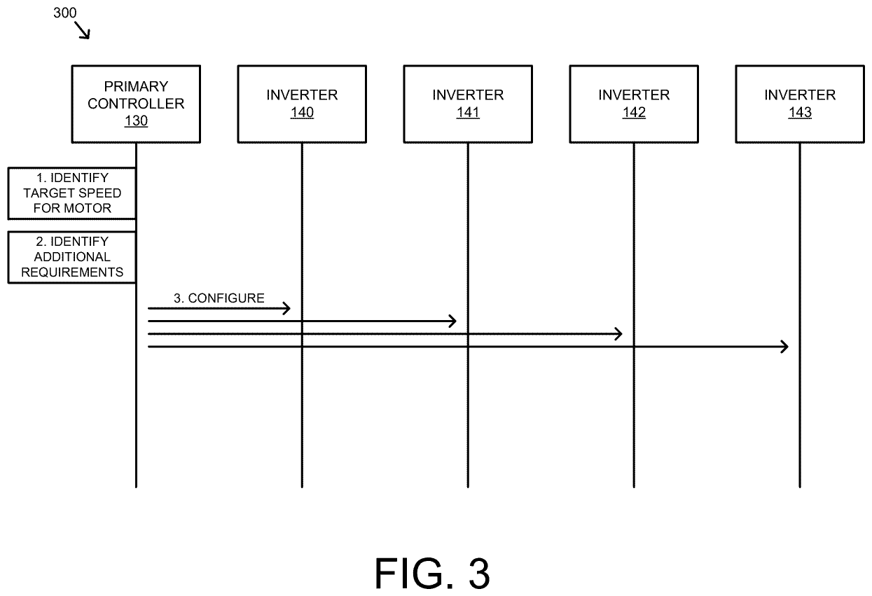

FIG. 3 illustrates a timing diagram of configuring inverters associated with a motor according to an implementation.

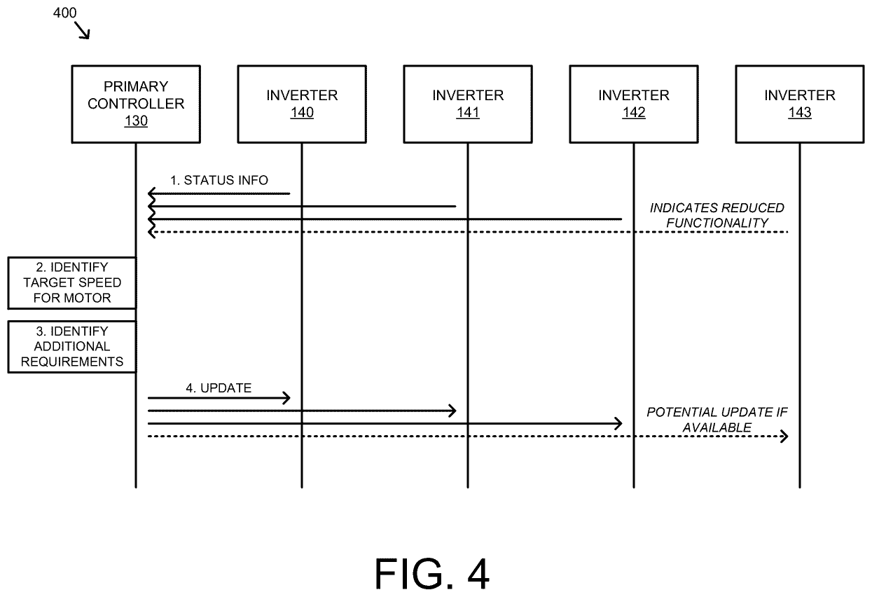

FIG. 4 illustrates a timing diagram of configuring inverters associated with a motor according to an implementation.

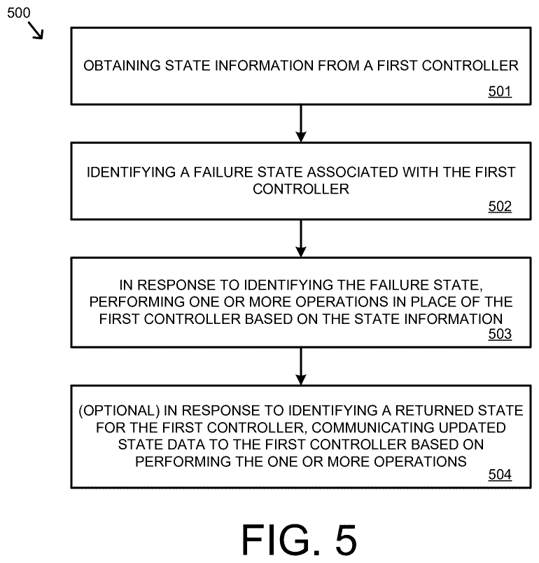

FIG. 5 illustrates a method of operating a set of controllers to provide failover for inverter control according to an implementation.

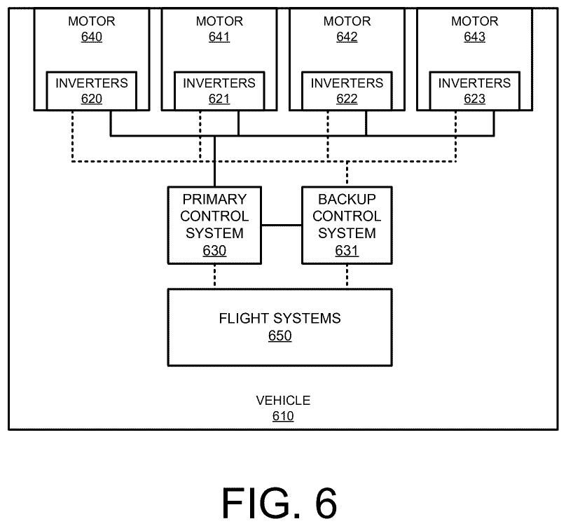

FIG. 6 illustrates a system of motors for a vehicle according to an implementation.

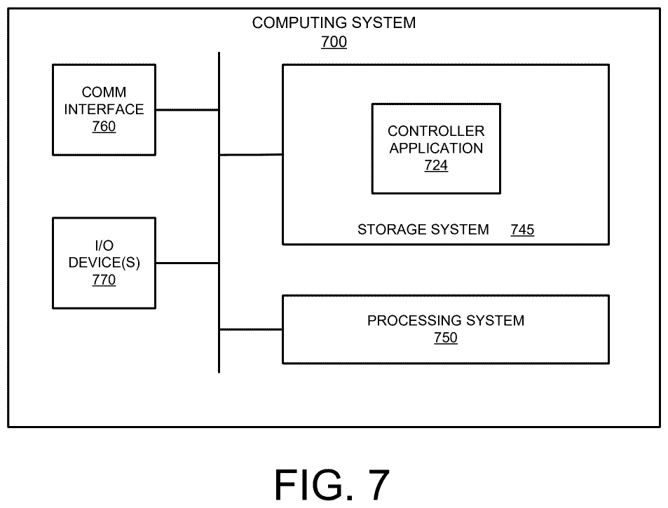

FIG. 7 illustrates a computing system that controls motor inverters according to an implementation.

### DETAILED DESCRIPTION

An inverter controls the motion of a motor by converting direct current (DC) from a power source into alternating current (AC) with adjustable frequency and voltage, which then drives the motor. The inverter controls the motor's speed and torque by modulating the frequency and voltage of the AC output. This process can involve pulse width modulation

(PWM) to generate a variable output that matches the motor's requirements, ensuring efficient operation and dynamic response to changes in load conditions. However, a technical problem exists in managing motors that use multiple inverters to provide the desired speed and torque associated with a motor.

As at least one technical solution, a system includes a controller that manages two or more inverters associated with a motor. The system can use the two or more inverters to provide finer control and redundancy. Each inverter independently converts DC to AC, allowing for precise control of different motor phases or sections. This setup can improve performance by providing better torque distribution, smoother operation, and enhanced fault tolerance. By coordinating the outputs of multiple inverters, the system can handle higher power demands, offer more precise speed and position control, and maintain operation even if one inverter fails, ensuring continuous and efficient performance in demanding environments.

In at least one implementation, a controller is communicatively coupled to each of the inverters to provide configuration updates and to receive status information associated with the inverters and/or the motor. In at least one example, the controller can be coupled to each inverter using Fibre Channel and a corresponding Fibre Channel protocol. The technical effect of using a Fibre Channel limits electronic interference in some environments, which can restrict or stop configuration updates from being delivered to each of the inverters. In other examples, the controller can be coupled to each inverter using ethernet, InfiniBand, or some other communication mechanism to support the communication of updates and status information from the inverters.

In at least one implementation, the controller can be configured to identify a target speed or torque associated with the motor and identify status information associated with the motor's inverters. Based on the target speed or torque associated with the motor and the status information, the controller can provide updates to at least one of the inverters to support the desired functionality of the motor. In at least one implementation, the controller can identify a failure or non-functionality associated with an inverter. An inverter can fail due to overloading, heat and thermal stress, electrical surges, component aging, or the use of poor-quality or defective components. Overloading the inverter is caused by exceeding the inverter's capacity, which can cause overheating and damage. Excessive heat, which can be caused by inadequate ventilation or high ambient temperatures, can stress internal components. Electrical surges from power disturbances can harm sensitive electronics associated with the inverter. Over time, components like capacitors degrade, reducing performance.

Additionally, using low-quality or defective components can lead to premature failure of portions of the inverter. In some implementations, the inverter can explicitly indicate a failure to the controller. In other implementations, the controller can be configured to identify the failure based on status information not being received within a threshold time (e.g., time). For example, the controller can be configured to receive a status update from an inverter every tenth of a second. If a status update is not received within the required period, the controller can identify a failure associated with the inverter.

In response to identifying the failure of the inverter, the controller can generate one or more updates to the remaining inverters, permitting the remaining inverters to overcome the effects of the failed inverter. The controller can provide an update that adjusts the frequency, current, and/or voltage associated with the remaining inverters to overcome the failure of the inverter. For example, when a failure occurs in association with an inverter, the remaining inverters can be updated to provide a different frequency and voltage to support the designated speed and torque required from the motor. The technical effect, especially in industrial or aviation applications, permits a set of one or more inverters to maintain the functionality of a motor after the failure of a first inverter. In at least one implementation, the system can include three or more inverters, wherein a set of inverters can be used to offset the failure of at least one inverter for the motor. For example, the controller can identify the failure associated with a first inverter and use two or more additional inverters to support the motor's desired functionality (e.g., the speed or torque from the motor).

In at least one technical solution, the controller can identify various preferences associated with using the motor. The preferences can include a motor speed preference, torque preference, power consumption preference, redundancy preference, or some other preference. The controller can be configured based on the preferences to identify a configuration update for each inverter associated with the motor. The configuration update can update the frequency, voltage, or current supplied by each inverter to support the preference. In at least one example, the controller can be configured to apply a model that receives the desired preferences as inputs and processes the inputs to determine configuration updates for the inverters associated with the motor.

In at least one technical solution, a motor deployment may include a first controller and a second controller that is used to provide high availability or failover when the first controller fails or becomes inoperable. In some implementations, a second controller can provide failover support for a first controller. The second controller can receive status information from the first controller, including health information, status information associated with the inverters (temperature, health, and the like), configuration for the inverters, or some other information. From the status information of the first controller, the second controller can determine when the first controller fails. The second controller can determine that the first controller fails when a message is not received during a period, can determine that the first controller fails when the first controller expressly indicates an issue, or can determine that the first controller fails based on some other information provided as part of the exchange between the first controller and the second controller. When the second controller determines that there is a failure associated with the first controller, the second controller can assume the operations or responsibilities of the first controller. The operations can include identifying status information associated with each of the inverters, identifying status information associated with the motor (e.g., speed, torque, and the like), providing updates to the inverters to provide the requested speed for the motor, providing updates to the inverters to provide a requested quantity of torque from the motor, or providing some other operation that was previously provided to the first inverter.

In at least one example, the first controller can provide state information to the second controller prior to the failure. The state information can correspond to the inverter and/or the motor. In some implementations, the state information includes the motor's current and requested speed and torque information. In some implementations, the state information includes voltage, frequency, and current information associated with the configuration of the inverters for the motor. At least one technical effect of receiving the state information from the first controller is that the second controller can efficiently assume the first controller's responsibilities after detecting the first controller's failure.

FIG. 1 illustrates a system 100 that manages inverters for a motor according to an implementation. System 100 includes primary controller 130, backup controller 131, and motor 110 with inverters 140, 141, 142, and 143 that support the motion of the motor. System 100 further includes updates 115, updates 116, status information 120, and status information 121. System 100 also includes state 160, which is exchanged between primary controller 130 and backup controller 131. Although demonstrated in the example of system 100 with four inverters for motor 110, a motor can use any number of two or more inverters to support the operation of motor 110. In at least one implementation, system 100 is deployed at a vehicle, such as an electric aircraft, electric car, or electric truck.

Inverters 140-143 can be configured to control motor 110 by operating in configurations such as parallel setups for higher power and redundancy or in multi-level inverter arrangements to create smoother, more precise AC output, reducing harmonics and enhancing performance. They can also be used in advanced control techniques like field-oriented control (FOC), where different inverters manage various motor parameters such as torque and flux for efficiency and dynamic response. In some examples, the multi-inverter approach provides increased flexibility, reliability, and fine-tuned motor operation.

In addition to inverters 140-143, system 100 further includes primary controller 130. Primary controller 130 receives status information 120 from at least inverters 140-143. Status information 120 can include temperature information for the inverters, power consumption information for the inverters, health information for the inverters (e.g., an indication of functional or non-functional), or some other status information. In some implementations, status information 120 can include battery status information, including charge, voltage, or other information associated with the battery providing the DC input to the inverters. In some examples, rather than being provided by the inverter, the battery status information can be provided by a battery (not shown). In some implementations, primary controller 130 can further identify status information associated with the current speed or current torque provided by motor 110. The status information can be provided by inverters 140-143 or other sensors on motor 110 (not shown).

In addition to receiving status information 120, primary controller 130 is configured to provide updates 115 to the configurations of inverters 140-143. Inverters 140-143 control motor 110 by converting DC (from a power source such as a battery) into AC and adjusting the frequency and voltage of this AC power. Adjusting the frequency and voltage allows precise motor speed and torque regulation. Here, updates 115 are used to configure at least one inverter of inverters 140-143 to change the voltage, current, or frequency supplied by the at least one inverter. The change can be used to provide the desired speed or torque associated with the motor. For example, the change can increase the voltage and frequency supplied by an inverter to increase the speed of the motor.

In some implementations, updates 115 are based at least partly on status information 120 received from inverters 140-143. For example, when an inverter is identified as non-functional (or partially functional), either from not receiving a status update or an explicit indication from the sensor data, primary controller 130 can provide an update to one or more of the inverters to provide failover for the non-functional (or limited functionality) inverter. As an example, if inverter 143 were identified as non-functional, then primary controller 130 can be configured to configure at least one inverter 140-142 to maintain the requested speed or torque associated with motor 110. The update can provide increased voltage, current, or frequency at an inverter 140-142 to overcome the non-functionality of inverter 143 or to replace the functionality of inverter 143.

As another illustrative example, primary controller 130 can identify the target power consumption for motor 110, a target torque from motor 110, and a target speed from motor 110. Primary controller 130 can update each inverter of inverters 140-143 to support the desired operation wherein the overall power consumption, target torque, and target speed are derived from a combination of inverters 140-143. Thus, in some configurations, primary controller 130 can be configured to update multiple inverters that provide the desired motor functionality (e.g., speed and torque).

In system 100, primary controller 130 further provides state 160 to backup controller 131 to support failover in the case of failure associated with primary controller 130. State 160 can include operational parameters such as inverter output voltage, frequency, motor speed, torque, and rotor position. It also involves synchronization signals for seamless transfer between controllers, power flow data like active and reactive power, and fault diagnostics such as overvoltage, overcurrent, or thermal conditions. This ensures the backup controller can take over with minimal disruption and maintain motor operation continuity. For example, when a failure or potential failure is identified in association with primary controller 130 (e.g., no status indication provided in a threshold period), backup controller 131 can support the control operations associated with the inverters of the motor.

Primary controller 130 and backup controller 131 can each include at least one central processing unit (CPU) or microcontroller that executes the operations described herein that are stored in computer-readable storage. Examples of storage can consist of hard drives, solid-state drives, memory cards, and the like. In some examples, primary controller 130 and backup controller 131 can include Field-Programmable Gate Arrays (FPGAs) and other processing systems like Application-Specific Integrated Circuits (ASICs) to provide the operations described herein. In some examples, primary controller 130 and backup controller 131 can be communicatively coupled to inverters 140-143 using Fibre Channel and a corresponding Fibre Channel protocol. However, primary controller 130 and backup controller 131 can be communicatively coupled to inverters 140-143 using ethernet or some other connection in some examples.

In some implementations, system 100 can be implemented in a vehicle, such as an electric aircraft, automobile, truck, or other electric vehicle. The vehicle can include one or more motors for the desired propulsion and operation. In some examples, a primary and backup controller can be configured to control the inverters associated with multiple motors. In other examples, a primary and backup controller can be configured to control inverters for a single motor. Additional controllers can provide the operations with other motors on the vehicle. In some implementations, for an electric aircraft, a set of motors are deployed to provide motion for the aircraft. In some exemplary implementations, the system can include four motors. The motors can provide lift and forward (or backward) propulsion. The motors can drive propellers or fans, generating thrust to move the aircraft.

In some implementations, when system 100 is implemented on an aircraft, primary controller 130 or backup controller 131 can be implemented wholly or partially with flight systems. Flight systems for an electric aircraft can include components designed to manage electric propulsion, energy storage, and overall flight control. The electric propulsion system can feature electric motors and power electronics to convert battery energy into thrust, while the energy storage system includes batteries or alternative energy sources like fuel cells to provide sustained power. Flight control systems can use control surfaces (e.g., ailerons, rudders, elevators) alongside avionics for stability, navigation, and autopilot functions. Thermal management systems can regulate the temperature of batteries and motors to maintain efficiency and safety.

FIG. 2 illustrates method 200 of operating a controller to manage inverters for a motor according to an implementation. Method 200 is referenced parenthetically in the following paragraphs with reference to elements of system 100 of FIG. 1. The steps of method 200 can be implemented in primary controller 130 of FIG. 1 in some examples.

Method 200 includes identifying (201) status information associated with two or more inverters for a motor. The status information can include operational data such as output voltage, current, and frequency, as well as motor parameters like speed, torque, and rotor position. It also includes thermal conditions (e.g., temperature of the inverter or motor), fault conditions (e.g., overcurrent, undervoltage, or overheating alerts), power flow metrics (e.g., active and reactive power), and system health indicators (e.g., diagnostics or self-check results). The information can be provided from one or more sensors associated with each of the inverters. In some examples, the status information can be provided by sensors associated with the motor or the battery supplying DC power to the inverters.

Method 200 further includes identifying (202) a target speed for the motor and generating (203) an update for at least one inverter of the two or more inverters based on the target speed and the status information. The update for the at least one inverter can be used to change the frequency associated with the inverter, the current supplied for the inverter, the voltage for the inverter, or some other update for the operation of the at least one inverter.

For example, the status information can indicate a decreased functionality or failure associated with an inverter. Consequently, the controller can change the configuration for the remaining inverters (and the reduced functionality inverter in some examples) to support the target speed. In some implementations, the controller can also consider other factors, including the motor's current speed, the current torque target for the motor, the current torque provided by the motor, or some other factor. As another example, if overheating or overcurrent is detected, the controller can reduce the load to the inverter, adjust switching frequencies for the inverter, or trigger a safe shutdown of the inverter. Further, using speed or torque data, the controller can fine-tune voltage or frequency outputs to improve efficiency or balance loads across the motor's inverters. Other updates can be provided to achieve the target speed while considering the status information associated with the various inverters.

Once the update is generated, method 200 further includes communicating (204) the update to the at least one inverter. The update can be provided in some implementations using a Fibre Channel protocol. The update can change the frequency, voltage, or current supplied by at least one inverter.

For example, primary controller 130 receives status information 120 from inverters 140-143 and determines a target speed associated with motor 110. When status information 120 indicates that inverter 143 is performing below a threshold, primary controller 130 can adjust configuration parameters related to any one of inverters 140-142 to overcome the potential issue with inverter 143. The update can be used to change the frequency of the inverters, increase voltage to the inverters, increase the current for the inverters, or provide some other update to give the target speed. In some examples, primary controller 130 may further update inverter 143 to reduce voltage, current, or frequency to reduce the load on inverter 143.

Although demonstrated using a target speed, similar operations can be performed based on the target torque, power consumption goals, or some other target, including combinations thereof. For example, referring to system 100, primary controller 130 can identify a target torque and an existing torque for motor 110. Primary controller 130 can determine updates to the inverters to support the change from the existing torque to the target torque, given the status information provided by the inverters.

In some implementations, when deployed in a vehicle, such as an electric airplane, the target speed or torque can include a minimum speed or torque to maintain the lift associated with the electric aircraft. For example, when an inverter demonstrates a decreased functionality or functionality below a threshold based on the status information, the controller can determine updates for at least one of the inverters to maintain the minimum lift for the aircraft. This minimum lift can be a minimum speed for the motor, a minimum torque for the motor, or some other minimum to maintain the safety associated with the aircraft.

FIG. 3 illustrates a timing diagram 300 of configuring inverters associated with a motor according to an implementation. Timing diagram 300 includes primary controller 130, and inverters 140-143 from system 100 of FIG. 1. Inverters 140-143 can be used on a single motor in configurations such as multi-phase systems or modular inverter setups to enhance performance, scalability, and fault tolerance.

In timing diagram 300, primary controller 130 identifies a speed for the motor at step 1 and identifies any additional requirements associated with the motor at step 2. The additional requirements can include battery usage requirements, torque requirements, or another requirement associated with the motor. Once the speed and any additional requirements are determined, primary controller 130 determines configurations for inverters 140-143 and communicates the configurations to inverters 140-143 at step 3. Primary controller 130 can configure motor inverters 140-143 by adjusting output voltage, frequency, and switching patterns to control motor speed, torque, and direction, and provide the desired motor speed identified in step 1. Primary controller 130 can modify PWM schemes based on operating conditions to optimize performance and efficiency or adapt control modes, such as transitioning between open-loop and closed-loop control. Primary controller 130 may also set protection thresholds, like overcurrent or overvoltage limits, and synchronize multiple inverters in multi-phase systems. These configurations enable effective motor control using inverters 140-143.

FIG. 4 illustrates a timing diagram 400 of configuring inverters associated with a motor according to an implementation. Timing diagram 300 includes primary controller 130, and inverters 140-143 from system 100 of FIG. 1. Inverters 140-143 can be used on a single motor in configurations such as multi-phase systems or modular inverter setups to enhance performance, scalability, and fault tolerance.

During the operation of a motor, primary controller 130 receives status information from inverters 140-143 at step 1. The status information can include operational data such as output voltage, current, frequency, and motor speed. They also send fault conditions like overcurrent, overvoltage, or thermal overload alerts, diagnostics for component health, and self-check results. Additional information includes power metrics such as active and reactive power, rotor position, and torque measurements. Environmental data, like temperature or humidity within the inverter enclosure, may also be shared. This status reporting allows the controller to monitor performance, adjust configurations, and respond to faults effectively.

In addition to identifying the status information, primary controller 130 identifies a target speed for the motor at step 2 and potential additional requirements associated with the motor at step 3. The additional requirements can include battery usage, torque requirements, current speed of the motor, current torque provided by the motor, or some other requirement related to the motor. At step 4, primary controller 130 determines an update for at least one of the inverters and communicates the update to the at least one inverter to support the target speed (or other targets associated with the motor). In some implementations, the update is provided to inverters 140-142 to support the reduced functionality associated with inverter 143 (e.g., inverter 143 with a temperature over a threshold). The update can reduce the load on inverter 143 or replace the operation of inverter 143. In some implementations, an update can be provided to inverter 143, if available, to reduce current, voltage, or some other parameter to reduce the load on inverter 143.

In some implementations, primary controller 130 can update output voltage, frequency, and switching patterns to provide the target motor speed identified in step 2 or any additional requirements identified in step 3. PWM schemes can be modified based on operating conditions to give the motor the target speed. Primary controller 130 may also set protection thresholds, like overcurrent or overvoltage limits, and synchronize multiple inverters in multi-phase systems. These configuration updates can support reduced functionality in an inverter or divert requirements from an inverter that satisfies various criteria related to temperature, overvoltage, etc.

Although demonstrated as reduced functionality with inverter 143. The configuration can be updated based on preferences, including battery usage requirements, temperature requirements, and the like. Accordingly, even when the target speed and target torque are constant for the motor, primary controller 130 can adjust frequency, voltage, or current to support the preferences. For example, primary controller 130 can manage the configuration of the inverters to maintain a desired power draw from the battery.

FIG. 5 illustrates method 500 of operating a set of controllers to provide failover for inverter control according to an implementation. Method 500 is referenced parenthetically in the following paragraphs with examples from system 100 of FIG. 1. Method 500 is an example method provided by backup controller 131.

Method 500 includes obtaining (501) state information from a first controller, wherein the state information corresponds to the state of a motor and the inverters on the motor. The state information may include real-time operational parameters like inverter output voltage, current, frequency, motor speed, torque, and rotor position. It also encompasses system configuration data, such as active inverter assignments, control modes (e.g., open-loop or closed-loop), and PWM settings. In some implementations, the state information can further include fault diagnostics and protection status (e.g., overcurrent or thermal alerts) are shared to ensure the standby controller can seamlessly take over if needed. The exchange ensures synchronization, continuity, and efficient fault handling for the operation of the motor.

Method 500 further includes identifying (502) a failure state associated with the state controller. The failure state can be identified by monitoring communication signals, such as heartbeat messages or synchronization updates, for interruptions or irregularities. For example, backup controller 131 can receive heartbeat messages periodically to determine that primary controller 130 is active. If a heartbeat message is not received in a threshold period, backup controller 131 can determine that the primary controller is non-functional. In some implementations, the backup controller can also compare real-time operational data from the motor and inverters against expected values and configurations set by the active controller to determine the failure state. Any deviations, such as missing control signals, failure to adjust parameters, or erratic behavior in motor operation, may indicate a fault. In some implementations, diagnostic error codes or failure to acknowledge status queries from the primary controller can alert the standby controller to a malfunction, prompting it to identify a failure state.

In response to identifying the failure state for the first controller, method 500 includes performing (503) one or more operations in place of the first controller based on the state information. The one or more operations can consist of managing and regulating the operation of the inverters for a motor to ensure motor performance. In some implementations, the standby motor adjusts output voltage, frequency, and phase parameters to control motor speed, torque, and direction. Based on sensor feedback, the controller implements control strategies like open-loop or closed-loop control to maintain precise motor operation. It also manages protection mechanisms by monitoring for faults like overcurrent, overvoltage, or overheating, and taking corrective actions to prevent damage. In some implementations, the standby controller can identify limited functionality in one or more inverters and adjust parameters associated with other inverters to provide the desired functionality (e.g., motor speed and torque). The standby controller can also maintain the state information for the motor and the inverters, such that the state information can be provided back to the first (primary) controller when the first controller becomes available. In some implementations, in response to identifying a returned state for the first controller (or identifying that the first controller is available), method 500 includes communicating (504) updated state data to the first controller based on performing the one or more operations. After providing the state data the first controller can return to being the active controller in some examples. In other examples, the first controller can act as a standby controller.

As an illustrative example, primary controller 130 communicates state 160 to backup controller 131. During the operation of system 100, backup controller 131 identifies a failure state associated with primary controller 130. In response to identifying the failure state, backup controller 131 can assume the operations of primary controller 130 in place of primary controller 130. In some implementations, backup controller 131 will notify primary controller 130 that it is assuming the operations. Once assumed, backup controller 131 can determine when primary controller 130 returns to an available or returned state and provide updated state data to primary controller 130.

FIG. 6 illustrates a system of motors for a vehicle according to an implementation. The system includes vehicle 610 with motors 640, 641, 642, and 643, inverters 620, 621, 622, and 623, primary control system 630, backup control system 631, and flight systems 650. Each of inverters 620, 621, 622, and 623 include multiple inverters (e.g., four, eight, etc.). For example, motors 640, 641, 642, and 643 can each include eight inverters. Vehicle 610 is representative of an electric aircraft. However, similar operations can be performed on a car, truck, or other vehicle that uses propulsion from electric motors.

Flight systems 650 can include avionics systems, which handle navigation, communication, and monitoring, such as GPS, autopilot, and radar. Flight systems 650 can manage the aircraft's altitude, direction, and stability through primary controls (ailerons, elevators, rudders (not pictured)) and secondary systems (flaps, slats, spoilers (not pictured)). Flight systems 650 can include electrical and hydraulic systems that power and actuate various components, while environmental systems can regulate cabin pressure, temperature, and oxygen levels. Additionally, flight systems 650 can include landing gear systems that provide safe takeoff and landing, and safety systems that can include emergency equipment and collision avoidance technologies.

In addition to flight systems 650, primary control system 630 and backup control system 631 are included. These control systems can be implemented wholly or partially as part of flight systems 650. Primary control system 630 and backup control system 631 can represent a single controller for each motor or a single controller for multiple motors, such as all motors 640-643. Primary control system 630 represents one or more active controllers, while backup control system 631 represents one or more backup controllers for the inverters.

Primary control system 630 obtains or identifies status information associated with inverters 620-623 and identifies targets associated with motors 640-643. The targets can include speed, torque, or other targets. Primary control system 630 can be configured to determine other information, such as the current or existing speed of the motor, current or existing torque provided by the motor, or some other information associated with the motor. The status information provided for the inverters can include output voltage, current and frequency, motor speed and torque, fault alerts (e.g., overcurrent, overheating), diagnostic codes, and operational health metrics for the controller. The status information can be used to configure the inverters to provide the desired functionality from the motors (e.g., speed and torque), which can be indicated from flight systems 650. The configuration of inverters 620-623 can include setting parameters such as output voltage, frequency, and phase for motor control, adjusting PWM schemes, selecting control modes (e.g., open-loop or closed-loop), defining protection thresholds (e.g., for overcurrent or overheating).

In some implementations, primary control system 630 can identify a limited functionality (e.g., overheating) associated with one or more inverters and overcome the limited functionality using the remaining inverters. For example, inverters 620 can be used on motor 640 to manage different phases or windings associated with the motor. When a failure or limited functionality occurs, the system can increase the load associated with the remaining inverters to support the desired functionality.

In some implementations, when a failure or limited functionality occurs, the system can target a motor speed or torque that maintains the propulsion required for lift of vehicle 610. As a technical effect, even if a desired speed is unattainable for the motor, the controller can target a speed that maintains lift to enhance the vehicle's safety. In some implementations, primary control system 630 can configure the inverters based on power preferences to keep required battery levels and ensure the vehicle preserves power for a predicted trip length. In some implementations, the system can manipulate the configuration of the various inverters to provide the desired speed and torque for each motor. Thus, based on the requests from flight systems 650 (e.g., speed request), primary control system 630 can update the configurations at the various inverters to support the request.

FIG. 7 illustrates a computing system 700 that controls motor inverters according to an implementation. Computing system 700 is representative of any computing system or systems with which the various operational architectures, processes, scenarios, and sequences disclosed herein for a controller. Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components such as a battery and enclosure that are not shown for clarity.

Communication interface 760 comprises components that communicate over communication links, such as network cards, ports, radio frequency, processing circuitry (and corresponding software), or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format-including combinations thereof. Communication interface 760 may be configured to communicate with one or more sensors associated with at least one motor and inverters for the at least one motor. In some implementations, communication interface 760 can communicate with the sensors using Fibre Channel. In some examples, communication interface 760 may further communicate with flight systems.

I/O device(s) 770 may include peripherals of a computer that facilitate the interaction between the user and computing system 700. Examples of I/O device(s) 770 may include keyboards, mice, trackpads, monitors, displays, printers, cameras, microphones, external storage devices, sensors, and the like. I/O device(s) 770 may be omitted in some examples.

Processing system 750 comprises microprocessor circuitry (e.g., at least one processor) and other circuitry that retrieves and executes operating software (i.e., program instructions) from storage system 745. Storage system 745 may include volatile and nonvolatile, removable, and non-removable media (or medium) implemented in any method or technology for storage of information, such as computer-readable instructions, data structures, program modules, or other data. Storage system 745 may be implemented as a single storage device and across multiple storage devices or sub-systems. Storage system 745 may comprise additional elements, such as a controller to read operating software from the storage systems. Examples of storage media (also referred to as computer-readable storage media or a computer-readable storage medium) include random access memory, read-only memory, magnetic disks, optical disks, and flash memory, as well as any combination or variation thereof, or any other type of storage media. In some implementations, the storage media may be non-transitory. In some instances, at least some storage media may be transitory. In no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises controller application 724. The operating software on storage system 745 may further include an operating system, utilities, drivers, network interfaces, applications, or some other type of software. When read and executed by processing system 750 the operating software on storage system 745 directs computing system 700 to operate as a computing device as described herein. In at least one implementation, the operating software can provide method 200 described in FIG. 2 or method 500 described in FIG. 5.

In at least one example, controller application 724 directs processing system 750 to identify or obtain status information associated with a first inverter and a second inverter for a motor and identify a target speed for the motor. Controller application 724 further directs processing system 750 to generate updates for the first inverter and the second inverter based on the target speed and the status information and communicate the updates to the first inverter and the second inverter.

In some implementations, controller application 724 identifies that a third inverter satisfies at least one criterion for being non-functional. The at least one criterion can include a sensor being non-responsive, temperatures exceeding a threshold, voltage or current values satisfying criteria, or another criterion. The updates to the first inverter and the second inverter can be used to overcome the non-functionality associated with the third inverter. In some implementations, controller application 724 can be configured to reduce the load on the third inverter in response to identifying that the inverter satisfies the criteria associated with non-functionality.

In some implementations, controller application 724 can support failover with a second controller by exchanging state information for the one or more motors on a vehicle and the inverters associated with the one or more motors. When a failover is detected, the second controller can provide the operations of controller application 724 in place of controller application 724.

Example clauses for the application can be found below.
Clause 1. A method comprising: in a controller: identifying first status information associated with a first inverter for a motor and second status information associated with a second inverter for the motor; identifying a target speed for the motor; generating at least one update for the first inverter or the second inverter based on the target speed, the first status information and the second status information; and communicating the at least one update to the first inverter or the second inverter.
Clause 2. The method of clause 1, further comprising, in the controller, identifying an existing speed or an existing torque for the motor from one or more sensors, and wherein generating the at least one update for the first inverter or the second inverter is further based on the existing speed or the existing torque for the motor.
Clause 3. The method of clause 1, further comprising: identifying that a third inverter for the motor is non-functional, wherein generating the at least one update for the first inverter or the second inverter is further based on identifying that the third inverter for the motor is non-functional, wherein the at least one update replaces a function of the third inverter using the first inverter and the second inverter.
Clause 4. The method of clause 1, wherein identifying the first status information and the second status information comprises identifying heat information or power consumption information associated with the first inverter and the second inverter.
Clause 5. The method of clause 1, wherein the controller comprises a first controller, and the method further comprising: in a second controller: identifying a failure associated with the first controller; and in response to identifying the failure associated with the first controller: identifying third status information associated with the first inverter and the second inverter; generating at least one additional update for the first inverter or the second inverter based on the target speed and the third status information; and communicating the at least one additional update to the first inverter and the second inverter.
Clause 6. The method of clause 5, wherein identifying the failure associated with the first controller comprises identifying that a message was not received from the first controller within a period.
Clause 7. The method of clause 5, further comprising: in the second controller and prior to the failure: obtaining state information from the first controller, the state information comprising at least configuration information for the first inverter and the second inverter.
Clause 8. The method of clause 1, wherein communicating the at least one update to the first inverter or the second inverter comprises communicating the at least one update to the first inverter or the second inverter using a Fibre Channel protocol.
Clause 9. The method of clause 1, wherein the at least one update comprises a change of frequency, voltage, or current supplied by the first inverter or the second inverter.
Clause 10. A system comprising: a motor; a first inverter to support motion of the motor; a second inverter to support motion of the motor; and a controller communicatively coupled to the first inverter and the second inverter and configured to: identify status information associated with each of the first inverter and the second inverter; identify a target speed for the motor; generate updates for the first inverter or the second inverter based on the target speed and the status information; and communicate the updates to the first inverter and the second inverter.
Clause 11. The system of clause 10, wherein the controller is further configured to: identify a power target for the motor, wherein generating the updates for the first inverter and the second inverter based on the target speed and the status information is further based on the power target for the motor.
Clause 12. The system of clause 10, wherein the controller is further configured to: identify that a third inverter to support motion of the motor is non-functional, wherein generating the updates for the first inverter and the second inverter is further based on identifying that the third inverter for the motor is non-functional, wherein the updates replace a function of the third inverter using the first inverter and the second inverter.
Clause 13. The system of clause 10, wherein identifying the status information comprises identifying heat information or power consumption information associated with the first inverter and the second inverter.
Clause 14. The system of clause 10, wherein the controller comprises a first controller, and wherein the system further comprises a second controller communicatively coupled to the first controller, the first inverter, and the second inverter, and the second controller configured to: identify a failure associated with the first controller; in response to identifying the failure associated with the first controller: identify second status information associated with the first inverter and the second inverter; generate second updates for the first inverter and the second inverter based on the target speed and the second status information; and communicate the second updates to the first inverter and the second inverter.
Clause 15. The system of clause 14, wherein identifying the failure associated with the first controller comprises identifying that a message was not received from the first controller within a period.
Clause 16. The system of clause 10, wherein communicating the updates to the first inverter and the second inverter comprises communicating the updates to the first inverter and the second inverter using a Fibre Channel protocol.
Clause 17. The system of clause 10, wherein the updates comprise a change of frequency, voltage, or current supplied by the first inverter and the second inverter.
Clause 18. A computer-readable storage medium having program instructions stored thereon that, when executed by at least one processor, cause the at least one processor to execute operations, the operations comprising: identifying status information associated with at least a first inverter, a second inverter, and a third inverter for a motor; identifying a target speed for the motor; generating updates for the first inverter and the second inverter based on the target speed and the status information; and communicating the updates to the first inverter and the second inverter.
Clause 19. The computer-readable storage medium of clause 18, wherein the operations further comprise: identifying that the third inverter is non-functional, wherein generating the updates for the first inverter and the second inverter is further based on identifying that the third inverter is non-functional, wherein the updates replace a function of the third inverter using the first inverter and the second inverter.
Clause 20. The computer-readable storage medium of clause 18, wherein identifying the status information comprises identifying heat information or power consumption information associated with the first inverter, the second inverter, and the third inverter.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc., are used herein to indicate that a precise value or range thereof is not required and need not be specified. As used herein, the terms discussed above will have ready and instant meaning to one of ordinary skill in the art.

Moreover, terms such as up, down, top, bottom, side, end, front, back, etc., are used herein concerning a currently considered or illustrated orientation. Such terms must be correspondingly modified if they are considered concerning another orientation.

Further, in this specification and the appended claims, the singular forms “a,” “an” and “the” do not exclude the plural reference unless the context dictates otherwise. Moreover, conjunctions such as “and,” “or,” and “and/or” are inclusive unless the context dictates otherwise. For example, “A and/or B” includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture fairly falling within the scope of the claims of this patent.

What is claimed is:

1. A method comprising:
in a controller:
identifying first status information associated with a first inverter for a motor and second status information associated with a second inverter for the motor;
identifying a target speed for the motor;
generating at least one update for the first inverter or the second inverter based on the target speed, the first status information and the second status information; and
communicating the at least one update to the first inverter or the second inverter.

2. The method of claim 1, further comprising, in the controller, identifying an existing speed or an existing torque for the motor from one or more sensors, and wherein generating the at least one update for the first inverter or the second inverter is further based on the existing speed or the existing torque for the motor.

3. The method of claim 1, further comprising:
identifying that a third inverter for the motor is non-functional,
wherein generating the at least one update for the first inverter or the second inverter is further based on identifying that the third inverter for the motor is non-functional, wherein the at least one update replaces a function of the third inverter using the first inverter and the second inverter.

4. The method of claim 1, wherein identifying the first status information and the second status information comprises identifying heat information or power consumption information associated with the first inverter and the second inverter.

5. The method of claim 1, wherein the controller comprises a first controller, and the method further comprising:
in a second controller:
identifying a failure associated with the first controller; and
in response to identifying the failure associated with the first controller:
identifying third status information associated with the first inverter and the second inverter;
generating at least one additional update for the first inverter or the second inverter based on the target speed and the third status information; and
communicating the at least one additional update to the first inverter and the second inverter.

6. The method of claim 5, wherein identifying the failure associated with the first controller comprises identifying that a message was not received from the first controller within a period.

7. The method of claim 5, further comprising:
in the second controller and prior to the failure:
obtaining state information from the first controller, the state information comprising at least configuration information for the first inverter and the second inverter.

8. The method of claim 1, wherein communicating the at least one update to the first inverter or the second inverter comprises communicating the at least one update to the first inverter or the second inverter using a Fibre Channel protocol.

9. The method of claim 1, wherein the at least one update comprises a change of frequency, voltage, or current supplied by the first inverter or the second inverter.

10. A system comprising:
a motor;
a first inverter to support motion of the motor;
a second inverter to support motion of the motor; and
a controller communicatively coupled to the first inverter and the second inverter and configured to:
identify status information associated with each of the first inverter and the second inverter;
identify a target speed for the motor;
generate updates for the first inverter or the second inverter based on the target speed and the status information; and
communicate the updates to the first inverter and the second inverter.

11. The system of claim 10, wherein the controller is further configured to:
identify a power target for the motor,
wherein generating the updates for the first inverter and the second inverter based on the target speed and the status information is further based on the power target for the motor.

12. The system of claim 10, wherein the controller is further configured to:
identify that a third inverter to support motion of the motor is non-functional,
wherein generating the updates for the first inverter and the second inverter is further based on identifying that the third inverter for the motor is non-functional, wherein the updates replace a function of the third inverter using the first inverter and the second inverter.

13. The system of claim 10, wherein identifying the status information comprises identifying heat information or power consumption information associated with the first inverter and the second inverter.

14. The system of claim 10, wherein the controller comprises a first controller, and wherein the system further comprises a second controller communicatively coupled to the first controller, the first inverter, and the second inverter, and the second controller configured to:
identify a failure associated with the first controller;
in response to identifying the failure associated with the first controller:
identify second status information associated with the first inverter and the second inverter;
generate second updates for the first inverter and the second inverter based on the target speed and the second status information; and
communicate the second updates to the first inverter and the second inverter.

15. The system of claim 14, wherein identifying the failure associated with the first controller comprises identifying that a message was not received from the first controller within a period.

16. The system of claim 10, wherein communicating the updates to the first inverter and the second inverter comprises communicating the updates to the first inverter and the second inverter using a Fibre Channel protocol.

17. The system of claim 10, wherein the updates comprise a change of frequency, voltage, or current supplied by the first inverter and the second inverter.

18. A computer-readable storage medium having program instructions stored thereon that, when executed by at least one processor, cause the at least one processor to execute operations, the operations comprising:
identifying status information associated with at least a first inverter, a second inverter, and a third inverter for a motor;
identifying a target speed for the motor;
generating updates for the first inverter and the second inverter based on the target speed and the status information; and
communicating the updates to the first inverter and the second inverter.

19. The computer-readable storage medium of claim 18, wherein the operations further comprise:
identifying that the third inverter is non-functional,
wherein generating the updates for the first inverter and the second inverter is further based on identifying that the third inverter is non-functional, wherein the updates replace a function of the third inverter using the first inverter and the second inverter.

20. The computer-readable storage medium of claim 18, wherein identifying the status information comprises identifying heat information or power consumption information associated with the first inverter, the second inverter, and the third inverter.
